(19) United States
(12) Patent Application Publication
(10) Pub. No.: US 2026/0188730 A1
(43) Pub. Date: Jul. 2, 2026

(54) SOLID ELECTROLYTE, AND SODIUM BATTERY AND SODIUM BATTERY MODULE INCLUDING THE SOLID ELECTROLYTE

(71) Applicant: Samsung Electronics Co., Ltd., Suwon-si (KR)

(72) Inventors: Joungwon Park, Suwon-si (KR); Hyunpyo Lee, Suwon-si (KR)

(21) Appl. No.: 19/421,719

(22) Filed: Dec. 16, 2025

(30) Foreign Application Priority Data
Dec. 30, 2024 (KR) 10-2024-0201097

(51) Int. Cl. H01M 10/0562; H01M 10/054

(52) U.S. Cl. CPC H01M 10/0562; H01M 10/054; H01M 2300/008

(57) ABSTRACT

A solid electrolyte, and a sodium battery and a sodium battery module, which include the solid electrolyte. The solid electrolyte includes a solid ion conductor represented by Formula 1:

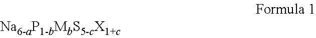

wherein M, X, a, b and c in Formula 1 are as disclosed in the specification.

### CROSS-REFERENCE TO RELATED APPLICATION

This application claims priority to Korean Patent Application No. 10⁻²⁰²⁴-0201097, filed on Dec. 30, 2024, in the Korean Intellectual Property Office, and all the benefits accruing therefrom under 35 U.S.C. § 119, the disclosure of which is incorporated by reference herein in its entirety.

### BACKGROUND

### 1. Field

The disclosure relates to a solid electrolyte, and a sodium battery and a sodium battery module which include the solid electrolyte.

### 2. Description of the Related Art

Sodium batteries are being researched extensively as next-generation batteries due to lower prices and lower geopolitical risks of sodium as compared to lithium in lithium batteries. However, in order to compete with the energy density of lithium-ion all-solid batteries, the improvement in electron density of sodium all-solid batteries is attracting attention. Sodium all-solid batteries require sodium solid ion conductor-containing solid electrolytes having sodium ion conductivity.

Solid ion conductor-containing solid electrolytes with a composition of Na₃PS₄ are the most extensively researched as sodium ion conductor-containing solid electrolytes. Solid ion conductor-containing solid electrolytes with a composition of Na₃PS₄ have a Na ion conductivity of 10⁻⁵ Siemens per centimeter (S/cm), but may have a problem in that charging or discharging rates are not as efficient or consistent over time due in-part to a high overvoltage at general charge/discharge current densities.

Therefore, there is a need for a solid electrolyte having improved Na ion conductivity and electrochemical stability to develop a high-energy sodium battery, and a sodium battery and sodium battery module which include the solid electrolyte.

### SUMMARY

Provided is a solid electrolyte having high Na ion conductivity and high electrochemical stability.

Provided is a sodium battery including the solid electrolyte.

Provided is a sodium battery module including the solid electrolyte.

Additional aspects will be set forth in part in the description which follows and, in part, will be apparent from the description, or may be learned by practice of the presented embodiments of the disclosure.

According to an aspect of the disclosure, there is provided a solid electrolyte including a solid ion conductor represented by Formula 1:

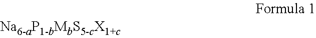

wherein, in Formula 1,
M may be a transition metal element having an oxidation number of +6,
X may be a halogen,
0≤a<2, 0<b<1, and 0≤c≤1.

According to an embodiment, in Formula 1, M may include at least one of tungsten (W), molybdenum (Mo), chromium (Cr), manganese (Mn), technetium (Tc), ruthenium (Ru), osmium (Os), iron (Fe), rhodium (Rh), rhenium (Re), or iridium (Ir).

According to an embodiment, in Formula 1, X may include at least one of chlorine (Cl), bromine (Br), or iodine (I).

According to an embodiment, in Formula 1, 0<b≤0.5.

According to an embodiment, the solid ion conductor may include at least one of: Na_{5.9}P_{0.9}W_{0.1}S₅Cl₁, Na_{5.9}P_{0.9}W_{0.1}S₅Br₁, Na_{5.9}P_{0.9}W_{0.1}S₅I₁, Na_{5.7}P_{0.9}W_{0.1}S_{4.8}Cl_{1.2}, Na_{5.7}P_{0.9}W_{0.1}S_{4.8}Br_{1.2}, Na_{5.7}P_{0.9}W_{0.1}S_{4.8}I_{1.2}, Na_{5.4}P_{0.9}W_{0.1} S_{4.5}Cl_{1.5}, Na_{5.4}P_{0.9}W_{0.1}S_{4.5}Br_{1.5}, Na_{5.4}P_{0.9}W_{0.1}S_{4.5}I_{1.5}, Na_{5.3}P_{0.8}W_{0.2}S_{4.5}Cl_{1.5}, Na_{5.3}P_{0.8}W_{0.2}S_{4.5}Br_{1.5}, Na_{5.3}P_{0.8}W_{0.2}S_{4.5}I_{1.5}, Na_{5.2}P_{0.9}W_{0.1}S_{4.3}Cl_{1.7}, Na_{5.2}P_{0.9}W_{0.1}S_{4.3}Br_{1.7}, Na_{5.2}P_{0.9}W_{0.1} S_{4.31}I_{1.7}, Na_{4.9}P_{0.9}W_{0.1} S₄Cl₂, Na_{4.9}P_{0.9}W_{0.1}S₄Br₂, or Na_{4.9}P_{0.9}W_{0.1}S₄I₂;
Na_{5.9}P_{0.9}Mo_{0.1}S₅Cl₁, Na_{5.9}P_{0.9}Mo_{0.1}S₅Br₁, Na_{5.9}P_{0.9}Mo_{0.1}S₅I₁, Na_{5.7}P_{0.9}Mo_{0.1}S_{4.8}Cl_{1.2}, Na_{5.7}P_{0.9}Mo_{0.1}S_{4.8}Br_{1.2}, Na_{5.7}P_{0.9}Mo_{0.1}S_{4.8}I_{1.2}, Na_{5.4}P_{0.9}Mo_{0.1}S_{4.5}Cl_{1.5}, Na_{5.4}P_{0.9}Mo_{0.1}S_{4.5}Br_{1.5}, Na_{5.4}P_{0.9}Mo_{0.1}S_{4.5}I_{1.5}, Na_{5.3}P_{0.8}Mo_{0.2}S_{4.5}Cl_{1.5}, Na_{5.3}P_{0.8}Mo_{0.2}S_{4.5}Br_{1.5}, Na_{5.3}P_{0.8}Mo_{0.2}S_{4.5}I_{1.5}, Na_{5.2}P_{0.9}Mo_{0.1}S_{4.3}Cl_{1.7}, Na_{5.2}P_{0.9}Mo_{0.1}S_{4.3}Br_{1.7}, Na_{5.2}P_{0.9}Mo_{0.1}S_{4.31}I_{1.7}, Na_{4.9}P_{0.9}Mo_{0.1}S₄Cl₂, Na_{4.9}P_{0.9}Mo_{0.1}S₄Br₂, or Na_{4.9}P_{0.9}Mo_{0.1}S₄I₂; and
Na_{5.9}P_{0.9}Cr_{0.1}S₅Cl₁, Na_{5.9}P_{0.9}Cr_{0.1}S₅Br₁, Na_{5.9}P_{0.9}Cr_{0.1}S₅I₁, Na_{5.7}P_{0.9}Cr_{0.1}S_{4.8}Cl_{1.2}, Na_{5.7}P_{0.9}Cr_{0.1}S_{4.8}Br_{1.2}, Na_{5.7}P_{0.9}Cr_{0.1}S_{4.8}I_{1.2}, Na_{5.4}P_{0.9}Cr_{0.1}S_{4.5}Cl_{1.5}, Na_{5.4}P_{0.9}Cr_{0.1}S_{4.5}Br_{1.5}, Na_{5.4}P_{0.9}Cr_{0.1}S_{4.5}I_{1.5}, Na_{5.3}P_{0.8}Cr_{0.2}S_{4.5}Cl_{1.5}, Na_{5.3}P_{0.8}Cr_{0.2}S_{4.5}Br_{1.5}, Na_{5.3}P_{0.8}Cr_{0.2}S_{4.5}I_{1.5}, Na_{5.2}P_{0.9}Cr_{0.1}S_{4.3}Cl_{1.7}, Na_{5.2}P_{0.9}Cr_{0.1}S_{4.3}Br_{1.7}, Na_{5.2}P_{0.9}Cr_{0.1}S_{4.31}I_{1.7}, Na_{4.9}P_{0.9}Cr_{0.1}S₄Cl₂, Na_{4.9}P_{0.9}Cr_{0.1}S₄Br₂, or Na_{4.9}P_{0.9}Cr_{0.1}S₄I₂.

According to an embodiment, the solid ion conductor may include a solid ion conductor represented by Formula 2:

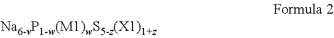

wherein, in Formula 2,
M1 may be tungsten (W) or molybdenum (Mo),
X1 may be chlorine (Cl), bromine (Br), or iodine (I),
0≤v≤1.3, 0<w<0.3, and 0≤z≤1.

According to an embodiment, the solid ion conductor may include an argyrodite-based crystalline material.

According to an embodiment, the solid ion conductor may have a composition in which the phosphorus (P) has an oxidation number of +5 and sulfur (S) has an oxidation number of −2.

According to an embodiment, the solid ion conductor may have a crystalline form in which a sodium (Na) vacancy is increased based on Na₆P₁S₅Cl₁.

According to an embodiment, the solid ion conductor may have a sodium (Na) ion conductivity of about 1.0×10⁻³ milliSiemen per centimeter (mScm⁻¹) to about 3.0×10¹ mScm⁻¹ at a temperature of 25° C.

According to another aspect of the disclosure, there is provided a sodium battery including a cathode layer, an anode layer, and a solid electrolyte layer disposed between the cathode layer and the anode layer,

wherein at least one of the cathode layer, the anode layer, and the solid electrolyte layer includes a solid electrolyte including a solid ion conductor represented by Formula 1:

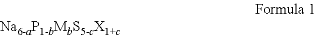

wherein, in Formula 1,
M may be a transition metal element having an oxidation number of +6,
X may be a halogen,
0≤a<2, 0<b<1, and 0≤c≤1.

According to an embodiment, the cathode layer may include a compound represented by Formula 12 below:

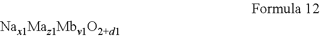

wherein, in Formula 12,
Ma may be at least one element of iron (Fe), manganese (Mn), cobalt (Co), nickel (Ni), ruthenium (Ru), osmium (Os), chromium (Cr), molybdenum (Mo), vanadium (V), or tungsten (W),
Mb may be at least one element of from Groups 4, 5, 7, 9, or 10 of the periodic table of the elements,
0.35≤x1<2, 0<z1≤5, 0≤v1≤0.7, and 0≤d1<1.

According to an embodiment, the cathode layer further may include the solid electrolyte.

A content of the solid electrolyte may be in a range of about 1 part by weight to about 40 parts by weight with respect to 100 parts by weight of a total weight of the cathode layer.

According to an embodiment, the anode layer may include sodium metal, a sodium metal-based alloy, a sodium intercalating compound, a carbon-based material, or a combination thereof.

According to an embodiment, the anode layer may include an anode active material layer of a sodium metal.

The anode active material layer may have a thickness of about 3 micrometers (μm) to about 500 μm.

According to an embodiment, the solid electrolyte may be further included in a protective film of the cathode layer or a protective film of the anode layer, or both of the protective films of the cathode layer and the anode layer.

In an embodiment, the sodium battery may be a sodium ion battery or an all-solid air battery.

According to another aspect of the disclosure, there is provided a sodium battery module, in which a plurality of sodium batteries are stacked, including a cathode layer, an anode layer, and a solid electrolyte layer disposed between the cathode layer and the anode layer.

wherein at least one of the cathode layer, the anode layer, and the solid electrolyte layer may include a solid electrolyte including a solid ion conductor represented by Formula 1 below:

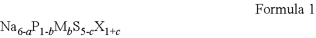

wherein, in Formula 1,
M may be a transition metal element having an oxidation number of +6,
X may be a halogen,
0≤a<2, 0<b<1, and 0≤c≤1.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a structure of an all-solid sodium ion battery according to an embodiment;

FIG. 2 is a schematic view of a structure of an all-solid sodium air battery according to an embodiment;

FIG. 3 shows results of analyzing symmetric cells including solid ion conductor-containing solid electrolyte layers prepared in Examples 1 to 8 by using electrochemical impedance spectroscopy (EIS) at room temperature (25° C.);

FIG. 4 shows results of analyzing symmetric cells including solid ion conductor-containing solid electrolyte layers prepared in Comparative Examples 1, 2, 4, and 6 by using EIS at room temperature (25° C.); and

FIG. 5 shows results of analyzing a symmetric cell including a solid ion conductor-containing solid electrolyte layer prepared in Comparative Example 3 by using EIS at room temperature (25° C.).

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, and by referring to the FIGS., to explain aspects.

As the present inventive concept allows for various changes and numerous embodiments, specific embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope are encompassed in the present inventive concept.

The expression “at least one” or “one or more” used in front of components in the present specification is meant to supplement a list of all components means, and does not imply to supplement individual components of the description. The term “combination” as used herein includes mixtures, alloys, reaction products, or the like, unless specifically stated otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that unless otherwise stated herein, the terms “comprises” and/or “comprising,” or “includes” and/or “including” do not preclude other elements, but further include other elements. As used herein, terms “first,” “second,” and the like are used to distinguish one component from another, without indicating order, quantity, or importance. As used herein, unless otherwise indicated or explicitly contradicted by context, it should be interpreted as including both singular and plural. The term “or” means “and/or” unless otherwise specified.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

Throughout the present specification, “an embodiment,” “example embodiment,” “exemplary embodiment,” and the like. are included in at least one embodiment in which specific elements described in connection with the embodiment are included in this specification, which means that these elements may or may not exist in another embodiment. Further, it should be understood that the described elements may be combined in any suitable manner in various embodiments.

All percent, parts, ratios and the like are by weight unless otherwise indicated. Further, when an amount, concentration, or other value or parameter, is given as a list of upper desirable values and lower desirable values, this is to be understood as specifically disclosing all ranges formed from any pair of an upper desirable value and a lower desirable value, regardless of whether ranges are separately disclosed.

When a range of numerical values is described herein, unless stated otherwise, the range is intended to include the terminal points thereof, and all integers and fractions within the range. The scope of the disclosure is not intended to be limited to the specific values mentioned when defining a range.

Unless otherwise specified, the unit “parts by weight” refers to a weight ratio between respective components, and the unit “parts by mass” refers to a value in which a weight ratio between respective components is converted into solid.

“About” as used herein is inclusive of the stated value and means within an acceptable range of deviation for the particular value as determined by one of ordinary skill in the art, considering the measurement in question and the error associated with measurement of the particular quantity (that is, the limitations of the measurement system). For example, “about” may mean within one or more standard deviations, or within ±10%, or ±5% of the stated value.

Unless otherwise defined, all terms (including technical and scientific terms) used herein have the same meaning as commonly understood by one or ordinary skill in the art to which the disclosure belongs. In addition, it will be further understood that terms, such as those defined in commonly used dictionaries, should be interpreted as having a meaning that is consistent with their meaning in the context of the relevant art and the disclosure and will not be interpreted in an idealized sense unless expressly so defined herein. Also, the terms should not be interpreted in an overly formal sense.

Embodiments are described herein with reference to cross-sectional views which are schematic diagrams of idealized embodiments. Therefore, the appearance of the example may vary, for example, as a result of manufacturing techniques and/or tolerances. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. In the drawings, the thicknesses of layers and regions are exaggerated for clarity. Thus, regions illustrated in the drawings are schematic in nature and their shapes are not intended to illustrate the actual shape of a region and are not intended to limit the scope of the claims.

As electrolytes for all-solid lithium batteries, argyrodite-type solid ion conductors are known to have high ion conductivity and stable interfacial properties. In this way, attempts have been made to synthesize a sodium argyrodite-type solid ion conductor for an all-solid sodium battery. However, unlike a lithium solid ion conductor, the sodium argyrodite-type solid ion conductor is not easy (difficult) to synthesize and the structure is not well defined nor consistent. A synthesized Na₆PS₅Cl has a sodium ion conductivity of 1.2×10⁻⁵ millisiemens per centimeter (mS/cm), which is very lower than that of Li₆PS₅Cl which has a lithium ion conductivity of 3×10⁻³ mS/cm.

In order to solve these problems, the inventors of the disclosure propose a solid electrolyte with a new composition, and a sodium battery and a sodium battery module which include the solid electrolyte.

Hereinafter, a solid electrolyte, and a sodium battery and a sodium battery module which include the solid electrolyte will be described in more detail through embodiments.

### Solid Electrolyte

A solid electrolyte according to an embodiment may include a solid ion conductor represented by Formula 1:

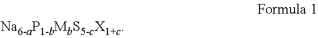

In Formula 1,
M may be a transition metal element having an oxidation number of ±6,
X may be a halogen,
0≤a<2, 0<b<1, ans 0≤c≤1.

In the solid electrolyte according to an embodiment, in Formula 1, M may include at least one of tungsten (W), molybdenum (Mo), chromium (Cr), manganese (Mn), technetium (Tc), ruthenium (Ru), osmium (Os), iron (Fe), rhodium (Rh), rhenium (Re), or iridium (Ir).

For example, M may include at least one of tungsten (W), molybdenum (Mo), or chromium (Cr). For example, M may include at least one of tungsten (W) or molybdenum (Mo).

In the solid electrolyte according to an embodiment, in Formula 1, X may include at least one of chlorine (Cl), bromine (Br), or iodine (I). For example, X may include at least one of chlorine (Cl) or bromine (Br).

In the solid electrolyte according to an embodiment, in Formula 1, 0<b≤0.5, 0<b≤0.4, 0<b≤0.3, or 0<b≤0.2.

In the solid electrolyte according to an embodiment, the solid ion conductor may include at least one of:
Na_{5.9}P_{0.9}W_{0.1}S₅Cl₁, Na_{5.9}P_{0.9}W_{0.1}S₅Br₁, Na_{5.9}P_{0.9}W_{0.1}S₅I₁, Na_{5.7}P_{0.9}W_{0.1}S_{4.8}Cl_{1.2}, Na_{5.7}P_{0.9}W_{0.1}S_{4.8}Br_{1.2}, Na_{5.7}P_{0.9}W_{0.1}S_{4.8}I_{1.2}, Na_{5.4}P_{0.9}W_{0.1}S_{4.5}Cl_{1.5}, Na_{5.4}P_{0.9}W_{0.1}S_{4.5}Br_{1.5}, Na_{5.4}P_{0.9}W_{0.1}S_{4.5}I_{1.5}, Na_{5.3}P_{0.8}W_{0.2}S_{4.5}Cl_{1.5}, Na_{5.3}P_{0.8}W_{0.2}S_{4.5}Br_{1.5}, Na_{5.3}P_{0.8}W_{0.2}S_{4.5}I_{1.5}, Na_{5.2}P_{0.9}W_{0.1}S_{4.3}Cl_{1.7}, Na_{5.2}P_{0.9}W_{0.1}S_{4.3}Br_{1.7}, Na_{5.2}P_{0.9}W_{0.1} S_{4.31}I_{1.7}, Na_{4.9}P_{0.9}W_{0.1} S₄Cl₂, Na_{4.9}P_{0.9}W_{0.1}S₄Br₂, or Na_{4.9}P_{0.9}W_{0.1}S₄I₂;
Na_{5.9}P_{0.9}Mo_{0.1}S₅Cl₁, Na_{5.9}P_{0.9}Mo_{0.1}S₅Br₁, Na_{5.9}P_{0.9}Mo_{0.1}S₅I₁, Na_{5.7}P_{0.9}Mo_{0.1}S_{4.8}Cl_{1.2}, Na_{5.7}P_{0.9}Mo_{0.1}S_{4.8}Br_{1.2}, Na_{5.7}P_{0.9}Mo_{0.1}S_{4.8}I_{1.2}, Na_{5.4}P_{0.9}Mo_{0.1}S_{4.5}Cl_{1.5}, Na_{5.4}P_{0.9}Mo_{0.1}S_{4.5}Br_{1.5}, Na_{5.4}P_{0.9}Mo_{0.1}S_{4.5}I_{1.5}, Na_{5.3}P_{0.8}Mo_{0.2}S_{4.5}Cl_{1.5}, Na_{5.3}P_{0.8}Mo_{0.2}S_{4.5}Br_{1.5}, Na_{5.3}P_{0.8}Mo_{0.2}S_{4.5}I_{1.5}, Na_{5.2}P_{0.9}Mo_{0.1}S_{4.3}Cl_{1.7}, Na_{5.2}P_{0.9}Mo_{0.1}S_{4.3}Br_{1.7}, Na_{5.2}P_{0.9}Mo_{0.1}S_{4.31}I_{1.7}, Na_{4.9}P_{0.9}Mo_{0.1}S₄Cl₂, Na_{4.9}P_{0.9}Mo_{0.1}S₄Br₂, or Na_{4.9}P_{0.9}Mo_{0.1}S₄I₂; and
Na_{5.9}P_{0.9}Cr_{0.1}S₅Cl₁, Na_{5.9}P_{0.9}Cr_{0.1}S₅Br₁, Na_{5.9}P_{0.9}Cr_{0.1}S₅I₁, Na_{5.7}P_{0.9}Cr_{0.1}S_{4.8}Cl_{1.2}, Na_{5.7}P_{0.9}Cr_{0.1}S_{4.8}Br_{1.2}, Na_{5.7}P_{0.9}Cr_{0.1}S_{4.8}I_{10.2}, Na_{5.4}P_{0.9}Cr_{0.1}S_{4.5}Cl_{1.5}, Na_{5.4}P_{0.9}Cr_{0.1}S_{4.5}Br_{1.5}, Na_{5.4}P_{0.9}Cr_{0.1}S_{4.5}I_{1.5}, Na_{5.3}P_{0.8}Cr_{0.2}S_{4.5}Cl_{1.5}, Na_{5.3}P_{0.8}Cr_{0.2}S_{4.5}Br_{1.5}, Na_{5.3}P_{0.8}Cr_{0.2}S_{4.5}I_{1.5}, Na_{5.2}P_{0.9}Cr_{0.1}S_{4.3}Cl_{1.7}, Na_{5.2}P_{0.9}Cr_{0.1}S_{4.3}Br_{1.7}, Na_{5.2}P_{0.9}Cr_{0.1}S_{4.3}I_{1.7}, Na_{4.9}P_{0.9}Cr_{0.1}S₄Cl₂, Na_{4.9}P_{0.9}Cr_{0.1}S₄Br₂, or Na_{4.9}P_{0.9}Cr_{0.1}S₄I₂.

For example, the solid ion conductor may include at least one of Na_{5.9}P_{0.9}W_{0.1}S₅Cl₁, Na_{5.9}P_{0.9}W_{0.1}S₅Br₁, Na_{5.9}P_{0.9}W_{0.1}S₅I₁, Na_{5.7}P_{0.9}W_{0.1}S_{4.8}Cl_{1.2}, Na_{5.7}P_{0.9}W_{0.1}S_{4.8}Br_{1.2}, Na_{5.7}P_{0.9}W_{0.1}S_{4.8}I_{1.2}, Na_{5.4}P_{0.9}W_{0.1}S_{4.5}Cl_{1.5}, Na_{5.4}P_{0.9}W_{0.1}S_{4.5}Br_{1.5}, Na_{5.4}P_{0.9}W_{0.1}S_{4.5}I_{1.5}, Na_{5.3}P_{0.8}W_{0.2}S_{4.5}Cl_{1.5}, Na_{5.3}P_{0.8}W_{0.2}S_{4.5}Br_{1.5}, Na_{5.3}P_{0.8}W_{0.2}S_{4.5}I_{1.5}, Na_{5.2}P_{0.9}W_{0.1}S_{4.3}Cl_{1.7}, Na_{5.2}P_{0.9}W_{0.1}S_{4.3}Br_{1.7}, Na_{5.2}P_{0.9}W_{0.1}S_{4.31}I_{1.7}, Na_{4.9}P_{0.9}W_{0.1}S₄Cl₂, Na_{4.9}P_{0.9}W_{0.1}S₄Br₂, or Na_{4.9}P_{0.9}W_{0.1}S₄I₂.

In the solid electrolyte according to an embodiment, the solid ion conductor may include a solid ion conductor represented by Formula 2:

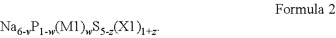

In Formula 2,
M1 may be tungsten (W) or molybdenum (Mo),
X1 may be chlorine (Cl), bromine (Br), or iodine (I),
0≤v≤1.3, 0<w<0.3, and 0≤z≤1.

In the solid electrolyte according to an embodiment, the solid ion conductor may include an argyrodite-based crystalline material.

In the solid electrolyte according to an embodiment, the solid ion conductor may have a composition in which some or all of phosphorus (P) have an oxidation number of +5 and some or all sulfur (S) have an oxidation number of −2. The solid ion conductor may have a composition in which some of the phosphorus (P) cations having an oxidation number of +5 are substituted with transition metal elements having an oxidation number of +6, for example, substituted with one of tungsten (W), molybdenum (Mo), and chromium (Cr) or a combination of two or more elements and may also have a composition in which some of the sulfur (S) anions having an oxidation number of −2 are substituted with halogens, for example, substituted with one of chlorine (Cl), bromine (Br), and iodine (I) or a combination of two or more elements.

A solid ion conductor having a composition in which most or all, e.g., from 50% to 100%, of phosphorous cations and sulfur anions are substituted may have an improved sodium ion conductivity of 10² or more at room temperature as compared to a solid ion conductor having a composition in which some, e.g., less than 40% or less than 30%, of phosphorus (P) cations having an oxidation number of +5 and sulfur (S) anions having an oxidation number of −2 are substituted.

The solid ion conductor of the solid electrolyte according to an embodiment may have a crystalline form in which sodium (Na) vacancy defects are increased based on Na₆PS₅Cl₁. These substitution-type vacancy defects may change the reactivity of the solid electrolyte and may also affect the density and ion conductivity of the solid electrolyte. In the solid ion conductor of the solid electrolyte according to an embodiment, Na ion conductivity may be improved by increasing sodium (Na) vacancy defects through substitutional doping of a transition metal element having an oxidation number of +6 and a halogen having an oxidation number of −1 in Formula 1.

More specifically, in a region in which some of phosphorus cations and sulfur anions are substituted, vacancies (or vacant lattice points) may be generated, and Schottky defects which are a type of point defect may be generated. A solid electrolyte in which Schottky defects are generated may maintain the overall frame structure, a lattice volume may be changed, and as the lattice volume increases, channels with a size that is more suitable for sodium (Na) ion movement may be formed, thereby improving Na ion conductivity.

In the solid electrolyte according to an embodiment, the solid ion conductor may have an ion conductivity of about 1.0×10⁻³ mScm⁻¹ to about 3.0×10¹ mScm⁻¹ at a temperature of 25° C. For example, the ion conductivity of the solid ion conductor at a temperature of 25° C. may be 2.0×10⁻³ mScm⁻¹ or more, 3.0×10⁻³ mScm⁻¹ or more, 4.0×10-3 mScm⁻¹ or more, 5.0×10⁻³ mScm⁻¹ or more, 6.0×10⁻³ mScm⁻¹ or more, 7.0×10⁻³ mScm⁻¹ or more, 8.0×10⁻³ mScm⁻¹ or more, 9.0×10⁻³ mScm⁻¹ or more, 1.0×10⁻² mScm⁻¹ or more, 2.0 x10⁻² mScm⁻¹ or more, 3.0×10⁻² mScm⁻¹ or more, 4.0×10⁻² mScm⁻¹ or more, 5.0×10⁻² mScm⁻¹ or more, or 6.0×10⁻² mScm⁻¹ or more. For example, the ion conductivity of the solid ion conductor at a temperature of 25° C. may be 2.8×10¹ mScm⁻¹, 2.5×10¹ mScm⁻¹, 2.2×10¹ mScm⁻¹, 1.9×10¹ mScm⁻¹, 1.6×10¹ mScm⁻¹, 1.3×10¹ mScm⁻¹, 1.0×10¹ mScm⁻¹, 7.0×10⁰ mScm⁻¹, 5.0×10⁰ mScm⁻¹, or 3.0×10⁰ mScm⁻¹ or less.

The solid electrolyte according to an embodiment may have a thickness of about 0.1 μm to about 1.0 mm. The thickness of the solid electrolyte may be appropriately adjusted to satisfy the desired density and ion conductivity within the above range.

### Method of Preparing Solid Electrolyte

According to another embodiment, there may be provided a method of preparing a solid electrolyte, which is a method of preparing a solid electrolyte, the method including mechanically milling a solid ion conductor-forming precursor to provide a solid ion conductor-forming precursor mixture, and heat-treating the solid ion conductor-forming precursor mixture to prepare a solid ion conductor represented by Formula 1:

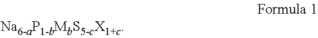

In Formula 1,
M may be a transition metal element having an oxidation number of +6,
X may be a halogen,
0≤a<2, 0<b≤1, and 0≤c≤1.

A solid electrolyte prepared through the method of preparing a solid electrolyte may have high ion conductivity and high electrochemical stability, and thus a sodium battery having high energy density may be implemented.

First, the solid ion conductor-forming precursor may be mechanically milled to provide the solid ion conductor-forming precursor mixture.

As the solid ion conductor-forming precursor, a sodium source, a phosphorus source, an M element source, a sulfur source, and a halogen source may be mechanically milled to prepare a milled mixture.

The M element source may be a transition metal element source having an oxidation number of +6. The M element source according to an embodiment may include at least one source of tungsten (W), molybdenum (Mo), or chromium (Cr).

The sodium source, the phosphorus source, the M element source, the sulfur source, and the halogen source may each include a sulfide, a halide, a nitride, an oxynitride, a nitrate, a hydroxide, and a carbonate of sodium, phosphorus, an M element, sulfur, and a halogen. For example, the sodium source, the phosphorus source, the M element source, the sulfur source, and the halogen source may each be a sulfide or a halide of sodium, phosphorus, an M element, sulfur, and a halogen.

The sodium source, the phosphorus source, the M element source, the sulfur source, and the halogen source may be put into a reactor in a stoichiometric ratio according to a composition of a solid ion conductor to be obtained, thereby performing mechanical milling.

Mechanical milling may be ball milling, air-jet milling, bead milling, roll milling, hand milling, high-energy ball milling, stirred ball milling, vibrating milling, mechanofusion milling, shaker milling, planetary milling, attritor milling, disk milling, shape milling, nauta milling, nobilta milling, high-speed mixing, or a combination thereof. For example, the mechanical milling may be performed by using ball milling, high-energy ball milling, mechanofusion milling, planetary milling, or the like.

The mechanical milling according to an embodiment may be planetary milling and may be performed at room temperature.

For example, the mechanical milling may be performed for a sufficient period of time by using a planetary ball mill having a rotational speed of about 300 revolutions per minute (rpm) to about 800 rpm. For example, the mechanical milling be performed for about 5 hours to about 20 hours, about 6 hours to about 15 hours, or about 7 hours to about 12 hours, but one or more embodiments are not limited thereto.

The mechanical milling may be performed by simultaneously or sequentially adding solid ion conductor-forming precursors.

Next, the solid ion conductor-forming precursor mixture may be heat-treated to prepare a solid ion conductor represented by Formula 1:

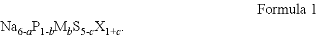

In Formula 1,
M may be a transition metal element having an oxidation number of +6,
X may be a halogen, 0≤a<2, 0<b<1, and 0≤c≤1.

For example, in Formula 1, M may include at least one of tungsten (W), molybdenum (Mo), chromium (Cr), manganese (Mn), technetium (Tc), ruthenium (Ru), osmium (Os), iron (Fe), rhodium (Rh), rhenium (Re), or iridium (Ir).

For example, M may include at least one of tungsten (W), molybdenum (Mo), or chromium (Cr). For example, M may include at least one of tungsten (W) or molybdenum (Mo).

For example, in Formula 1, X may include at least one of chlorine (Cl), bromine (Br), or iodine (I). For example, X may include at least one of chlorine (Cl) or bromine (Br).

In the solid electrolyte according to an embodiment, in Formula 1, 0<b≤0.5, 0<b≤0.4, 0<b≤0.3, or 0<b≤0.2.

The solid ion conductor-forming precursor mixture may be heat-treated at a temperature of about 400° C. to about 500° C. for about 1 hour to about 20 hours, about 3 hours to about 15 hours, or about 5 hours to about 12 hours in a vacuum atmosphere.

When the temperature of the heat treatment is excessively low, sintering reactivity may be insufficient, and when the temperature of the heat treatment is excessively high, phase decomposition may be induced or sodium may be volatilized. When the time of the heat treatment is excessively short, sintering reactivity may be insufficient, and when the time of the heat treatment is excessively long, sodium may be volatilized.

After the mechanical milling is performed, the method may further include molding.

### Sodium Battery and Sodium Battery Module

A sodium battery according to another embodiment may include a cathode layer, an anode layer, and a solid electrolyte layer disposed between the cathode layer and the anode layer, and at least one of the cathode layer, the anode layer, and the solid electrolyte layer may include the above-described solid electrolyte.

The solid electrolyte may be further included in a protective film of the cathode layer or a protective film of the anode layer, or both of the protective films of the cathode layer and the anode layer.

The sodium battery according to an embodiment may be a sodium ion battery or a sodium air battery. For example, the sodium battery may be an all-solid sodium ion battery or an all-solid sodium air battery.

### All-Solid Sodium Ion Battery

An all-solid sodium ion battery according to an embodiment may include a solid ion conductor-containing solid electrolyte having the composition described above.

The all-solid sodium ion battery may have high electrochemical stability by adopting a solid electrolyte having a new composition and improved ion conductivity.

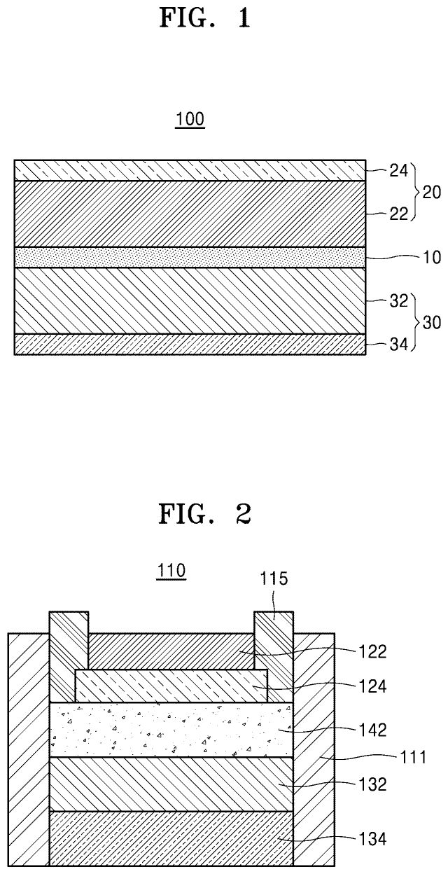

FIG. 1 is a schematic view of a structure of an all-solid sodium ion battery 100 according to an embodiment. The all-solid sodium ion battery 100 shown in FIG. 1 may be manufactured as follows.

### Solid Electrolyte Layer

First, a solid electrolyte layer 10 of a solid ion conductor having the composition described above may be prepared.

The solid electrolyte layer 10 may have a thickness of about 10 μm to about 1.0 mm. For example, the solid electrolyte layer 10 may have a thickness of about 10 μm to about 900 μm, about 10 μm to about 800 μm, about 10 μm to about 600 μm, about 10 μm to about 400 μm, or about 10 μm to about 200 μm.

### Cathode Layer

Next, a cathode layer 20 may be prepared. The cathode layer 20 may be prepared by forming a cathode active material layer 22 including a cathode active material on a cathode current collector 24. The cathode active material layer 22 may be prepared through a wet or dry method and may be prepared through, for example, a vapor phase method or a solid phase method. The vapor phase method may include pulse laser deposition (PLD), sputtering deposition, chemical vapor deposition (CVD), and the like, but one or more embodiments are not limited thereto. Any method may be used as long as the method may be used in the art. The solid phase method may include a sintering method, a sol-gel method, a doctor blade method, a screen printing method, a slurry casting method, a powder compression method, and the like, but one or more embodiments are not necessarily limited thereto. Any method may be used as long as the method may be used in the art.

The cathode current collector 24 may include a metal such as nickel, aluminum, titanium, copper, gold, silver, platinum, aluminum alloy, or stainless steel, for example, a material formed by plasma-spraying or arc-spraying a carbonaceous material, activated carbon fiber, nickel, aluminum, zinc, copper, tin, lead, or an alloy thereof, or for example, a conductive film obtained by dispersing a conducting agent into rubber or a resin such as a styrene-ethylene-butylene-styrene (SEBS) copolymer. For example, aluminum, nickel, stainless steel, or the like may be used. In particular, aluminum may be used because aluminum is easy to process into a thin film and is inexpensive. A shape of a current collector is not particularly limited, and for example, a thin film shape, a flat plate shape, a mesh shape, a net shape, a punched shape, an embossed shape, or a combination thereof (for example, a meshed flat plate shape) may be used. For example, an unevenness may be formed on a surface of a current collector through etching treatment.

As the cathode active material of the cathode active material layer 22, any material may be used without limitation as long as the material is commonly used in a sodium ion battery. The cathode active material may include a cathode active material including a sodium metal-containing oxide. The term “sodium metal-containing oxide” refers to an oxide including a metal element and/or a non-metal element other than sodium. For example, the sodium metal-containing oxide may be a layered compound, a spinel compound, or a polyanion compound.

The cathode active material according to an embodiment may include a compound represented by Formula 12:

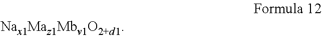

In Formula 12,
Ma may be at least one element of iron (Fe), manganese (Mn), cobalt (Co), nickel (Ni), ruthenium (Ru), osmium (Os), chromium (Cr), molybdenum (Mo), vanadium (V), or tungsten (W),
Mb may be at least one element of Groups 4, 5, 7, 9, or 10 of the periodic table of the elements,
   0.3≤x1<2, 0<z1≤5, 0≤v1≤0.7, and 0≤d1<1.

The cathode active material according to an embodiment may include: oxides represented by NaM¹ₐ₁O₂ such as NaFeO₂, NaMnO₂, NaNiO₂, and NaCoO₂, oxides represented by Na_{0.44}Mn₁₋ₐM¹ₐ₁O₂, or oxides represented by Na_{0.7}Mn₁₋ₐ₁M¹ₐ₁O_{2.05} (M¹ is at least one transition metal element and 0≤a1<1); oxides represented by Na_{b1}M²_{c1}Si₁₂O₃₀ such as Na₆Fe₂Si₁₂O₃₀ and Na₂Fe₅Si₁₂O₃₀ (M² is at least one transition metal element, 2≤b1≤6, and 2≤c1≤5); oxides represented by Na_{d′}M³ₑ₁Si₆O₁₈ such as Na₂Fe₂Si₆O₁₈ and Na₂MnFeSi₆O₁₈ (M³ is at least one transition metal element, 3≤d′≤6, and 1≤e1≤2); oxides represented by Na_{f}M⁴_{g}Si₂O₆ such as Na₂FeSiO₆ (M⁴ is at least one element of a transition metal element, Mg, or Al, 1≤f≤2, and 1≤g≤2); phosphates such as NaFePO₄ and Na₃Fe₂(PO₄)₃; borates such as NaFeBO₄ and Na₃Fe₂(BO₄)₃; or fluorides represented by NaₕM⁵F₆ such as Na₃FeF₆ and Na₂MnF₆ (M⁵ is at least one transition metal element and 2≤h≤3), but one or more embodiments are not necessarily limited thereto. Any material may be used as long as the material may be used in the art and may not deteriorate the performance of a sodium battery.

The cathode active material layer 22 may further include a conductive material, a binder, or a solid electrolyte in addition to the cathode active material.

The conductive material may include at least one of carbon materials having a high specific surface area, such as carbon black, activated carbon, acetylene black, and graphite particles, or a mixture of two or more thereof. In addition, the conductive material may include an electrically conductive fiber such as a fiber prepared by carbonizing vapor growth carbon or pitch (by-product of petroleum, coal, or coal tar) at a high temperature or a carbon fiber prepared from an acryl fiber (polyacrylonitrile). A carbon fiber and a carbon material having a high specific surface area may be simultaneously used. Electrical conductivity may be further improved by simultaneously using the carbon fiber and the carbon material having a high specific surface area. In addition, a metal-based conductive material, which is not oxidized and dissolved in a charging/discharging range of the cathode layer 20 and has lower electric resistance than a cathode active material, may be used. For example, a corrosion-resistant metal such as titanium or gold, a carbide such as SiC or WC, or a nitride such as Si₃N₄ or BN may be used. However, the conductive material used in the cathode layer 20 is not necessarily limited to those described above, and any material may be used as long as the material may be used as a conductive material in the art.

As the binder, a polymer of a fluorine compound (for example, a fluorine-based polymer) may be used. Examples of the fluorine compound may include fluorinated alkyl (C1-C18) (meth)acrylate, perfluoroalkyl (meth)acrylate (for example, perfluorododecyl (meth)acrylate, perfluoro n-octyl (meth)acrylate, or perfluoro n-butyl (meth)acrylate), perfluoroalkyl-substituted alkyl (meth)acrylate (for example, perfluorohexylethyl (meth)acrylate, perfluorooctylethyl (meth)acrylate), perfluorooxyalkyl (meth)acrylate (for example, perfluorododecyloxyethyl (meth)acrylate or perfluorodecyloxyethyl (meth)acrylate), fluorinated alkyl (C1-C18) crotonate, fluorinated alkyl (C1-C18) malate, fluorinated alkyl (C1-C18) malate fumarate, fluorinated alkyl (C1-C18) itaconate, fluorinated alkyl-substituted olefin (having 2 to10 carbon atoms and 1 to17 fluorine atoms) such as perfluorohexylethylene, fluorinated olefin having about 2 to10 carbon atoms and about 1 to 20 fluorine atoms, in which a fluorine atom is bonded to double bond carbon, tetrafluoroethylene, trifluoroethylene, vinylidene fluoride, or hexafluoropropylene.

In addition, the binder may include a copolymer of a fluoride compound and a monomer including an ethylenic double bond that does not include a fluorine atom.

In addition, the binder may include a non-fluorine-based polymer.

The non-fluorine-based polymer may be a polymer that do not include fluorine. For example, the non-fluorine-based polymer may be an addition polymer of a monomer including an ethylenic double bond that does not include a fluorine atom. Example of such a monomer may include: (cyclo)alkyl (C1-C22) (meth)acrylates (for example, methyl (meth)acrylate, ethyl (meth)acrylate, n-butyl (meth)acrylate, isobutyl (meth)acrylate, cyclohexyl (meth)acrylate, 2-ethylhexyl (meth)acrylate, isodecyl (meth)acrylate, lauryl (meth)acrylate, and octadecyl (meth)acrylate); aromatic ring-containing (meth)acrylates (for example, benzyl (meth)acrylate and phenylethyl (meth)acrylate); mono(meth)acrylates of alkylene glycol or dialkylene glycol (having 2 to 4 carbon atoms in an alkylene group) (for example, 2-hydroxyethyl (meth)acrylate, 2-hydroxypropyl (meth)acrylate, and diethylene glycol mono(meth)acrylate); (poly)glycerin mono(meth)acrylates (having a polymerization degree of 1 to 4); (meth)acrylate ester-based monomers such as multifunctional (meth)acrylate (for example, (poly)ethylene glycol di(meth)acrylate (having a polymerization degree of 1 to 100), (poly)propylene glycol di(meth)acrylate (having a polymerization degree of 1 to 100), 2,2-bis(4-hydroxyethylphenyl)propane di(meth)acrylate, and trimethylolpropane tri(meth)acrylate); (meth)acrylamide monomers such as (meth)acrylamide and a (meth)acrylamide derivative (for example, N-methylol(meth)acrylamide or diacetoneacrylamide); cyano group-containing monomer such as (meth)acrylonitrile, 2-cyanoethyl(meth)acrylate, and 2-cyanoethylacrylamide; styrene-based monomers such as styrene and a styrene derivative having 7 to 18 carbon atoms (for example, α-methylstyrene, vinyltoluene, p-hydroxystyrene, and divinylbenzene); diene-based monomers such as alkadiene having 4 to 12 carbon atoms (for example, butadiene, isoprene, and chloroprene); alkenyl ester-based monomers such as carboxylic acid (C2-Cl₂) vinyl esters (for example, vinyl acetate, vinyl propionate, vinyl butyrate, and vinyl octoate), and carboxylic acids (C2-Cl₂) (meth)allyl esters (for example, (meth)allyl acetate, (meth)allyl propionate, and (meth)allyl octoanoate); epoxy group-containing monomers such as glycidyl (meth)acrylate and (meth)allyl glycidyl ether; monoolefins such as monoolefins having 2 to 12 carbon atoms (for example, ethylene, propylene, 1-butene, 1-octene, and 1-dodecene); monomers containing chlorine, bromine or iodine atoms, or monomers containing halogen atoms other than fluorine such as vinyl chloride and vinylidene chloride; (meth)acrylic acids such as an acrylic acid and a methacrylic acid; and monomers having conjugated double bonds such as butadiene and isoprene. For example, the monomer may be polyethylene, polypropylene, or the like. In addition, the addition polymerization-typed polymer may be a copolymer such as an ethylene-vinyl acetate copolymer, a styrene-butadiene copolymer, or an ethylene-propylene copolymer. Furthermore, a carboxylic acid vinyl ester polymer may be partially or fully saponified as in polyvinyl alcohol (PVA) or the like.

In addition, examples of the binder may include: polysaccharide such as starch, methylcellulose, carboxymethylcellulose, hydroxymethylcellulose, hydroxyethylcellulose, hydroxypropylcellulose, carboxymethyl-hydroxyethylcellulose, or nitrocellulose, and a derivative thereof; a phenol resin; a melamine resin; a polyurethane resin; a urea resin; a polyamide resin; a polyimide resin; a polyamide-imide resin; petroleum pitch; and coal pitch. A plurality of binders may be used as the binder. In addition, the binder may serve as a thickener in an electrode mixture.

As the solid electrolyte, any material may be used without limitation as long as the material has desired ion conductivity, and examples thereof may include a solid ion conductor-containing solid electrolyte having the composition described above, a known oxide solid electrolyte, and/or a sulfide solid electrolyte. For example, a content of the solid electrolyte may be in a range of about 1 part by weight to about 40 parts by weight with respect to 100 parts by weight of the total weight of the cathode layer 20.

A thickness of the cathode active material layer 22 may be appropriately adjusted according to a configuration of a battery and may be, for example, in a range of about 0.1 μm to about 1 mm, but one or more embodiments are not limited thereto.

In addition, when the cathode active material layer 22 is prepared through a wet method, a solvent such as N-methylpyrrolidone, acetone. or water may be used. However, one or more embodiments are not limited thereto, and any material may be used as long as the material may be used in the art.

Contents of the cathode active material, the conductive material, the binder, and the solvent are at a level commonly used in a sodium ion battery. According to the use and configuration of a sodium ion battery, at least one of the conductive material, the binder, and the solvent may be omitted.

### Anode Layer

Next, an anode layer 30 may be prepared.

The anode layer 30 may be prepared by forming an anode active material layer 32 on an anode current collector 34. The anode active material layer 32 may be prepared through a wet or dry method and may be prepared, for example, through the same manner as the cathode active material layer 22.

The anode current collector 34 is not limited to a material, a shape, a preparation method, or the like, and any current collector may be used. For example, copper foil having a thickness of about 10 μm to about 100 μm, perforated copper foil having a thickness of about 10 μm to about 100 μm and a hole diameter of about 0.1 mm to about 10 mm, an expanded metal, a foamed metal plate, or the like may be used. In addition to copper, a material of the anode current collector 34 may include stainless steel, titanium, nickel, or the like.

The anode active material layer 32 may include a sodium metal, a sodium metal-based alloy, a sodium intercalating compound, a carbon-based material, or a combination thereof, but one or more embodiments are not necessarily limited thereto. Any material may be used as long as the material may be used as an anode active material layer material in the art and may include sodium or intercalate/deintercalate sodium.

Since the anode active material layer 32 determines the capacity of a sodium ion battery, for example, a sodium metal material may be used. Examples of the sodium metal-based alloy may include an alloy of sodium and aluminum, tin, indium, calcium, titanium, vanadium, or the like. For example, the anode active material layer 32 may include sodium in a metallic state with a thickness of about 3 μm to about 500 μm and may be used in various forms of a film, a sheet, foil, a net, a porous body, a foamed body, and a nonwoven fabric body.

When a material other than a sodium metal or a sodium alloy is used for the anode active material layer 32, a carbon-based material or the like having a graphene structure may be used. A mixed anode of a material such as graphite or graphitized carbon, a mixed anode of a carbon-based material and a metal or alloy, or a composite anode may be used.

The carbon-based material may include: a carbonaceous material such as natural graphite, artificial graphite, mesophase carbon, expanded graphite, a carbon fiber, a carbon fiber prepared by using a vapor phase growth method, a pitch-based carbonaceous material, needle coke, petroleum coke, a polyacrylonitrile-based carbon fiber, and carbon black which may electrochemically intercalate/deintercalate sodium ions; cyclic hydrocarbon having a five-membered ring or six-membered ring; or an amorphous carbon material synthesized by thermally decomposing a cyclic oxygen-containing organic compound.

The anode active material layer 32 according to an embodiment may further include a conductive material, a binder, and a solvent in addition to the materials described above, and the conductive material, binder, and solvent may be the same as those of the cathode layer 20.

Contents of the conductive material, the binder, and the solvent included in the anode active material layer 32 are at a level commonly used in a sodium ion battery. According to the use and configuration of a sodium ion battery, at least one of the conductive material, the binder, and the solvent may be omitted.

### Others

A sodium ion battery according to an embodiment may be sealed and accommodated in a battery case. The sodium ion battery may include an electrode tab that serves as an electrical path for guiding a current generated in the sodium ion battery to the outside. The battery case may include, for example, a cylindrical type, a prismatic type, a coin type, a cone type, a thin film type, or the like, but one or more embodiments are not limited thereto. For example, the battery case may be a battery case consisting of a SUS material.

The sodium ion battery may be a primary battery or a secondary battery but may be the secondary battery in terms of improving durability.

A plurality of sodium ion batteries may be stacked to form a battery module, and a plurality of battery modules may form a battery pack. The battery pack may be used in all devices requiring high capacity and high output power. For example, the battery pack may be used in laptop computers, smartphones, electric vehicles, and the like. A battery module may include, for example, a plurality of batteries and a frame for holding the plurality of batteries. For example, a battery pack may include a plurality of battery modules and a busbar for connecting the plurality of battery modules. The battery module and/or the battery pack may further include a cooling device. A plurality of battery packs may be adjusted by a battery management system. The battery management system may include a battery pack and a battery controller connected to the battery pack.

### All-Solid Sodium Air Battery

An all-solid sodium air battery according to an embodiment may include a solid ion conductor-containing solid electrolyte having the composition described above.

The all-solid sodium air battery may have high electrochemical stability by adopting a solid electrolyte having a new composition and improved ion conductivity.

FIG. 2 is a schematic view of a structure of an all-solid sodium air battery 110 according to an embodiment. As shown in FIG. 2, the all-solid sodium air battery 110 according to an embodiment may include an anode layer 132, a cathode layer 124 positioned opposite to the anode layer 132 with a certain interval therebetween, and a solid electrolyte layer 142 positioned between the anode layer 132 and the cathode layer 124. An anode current collector 134 may be disposed at one side of the anode layer 132, a cathode current collector 122 may be disposed at one side of the cathode layer 124, air exposure holes 115 may be formed at both sides of the cathode layer 124 to allow air to come into contact with the cathode layer 124, and an insulator housing 111 may be disposed at each of both sides of the anode layer 132, the cathode layer 124, and the solid electrolyte layer 142 to block the all-solid sodium air battery 110 from the outside.

### Anode Current Collector and Anode Layer

The anode current collector 134 may be a porous substrate and/or a mesh-shaped current collector. As used herein, the term “porous” generally refers to a material structure having a pore space.

The porous substrate may include at least one of graphite, a graphite intercalation compound, carbon black, carbon nanotubes, carbon nanofibers, graphene, an aluminum sponge, a titanium sponge, or an aluminum-titanium alloy sponge. Alternatively, the porous substrate may be formed from at least one of an aluminum sponge, a titanium sponge, or an aluminum-titanium alloy sponge and may include a covering layer of at least one of carbon or graphite, and the covering layer may have a thickness of less than about 1 μm. Alternatively, the porous substrate may be formed from at least one of electroconductive fibers, for example, carbon fibers or carbon mats including a metal filament such as a tantalum filament, a stainless steel filament, or a nickel filament, or felts or fiber nonwoven webs.

The mesh-shaped current collector may include a metal mesh. For example, the mesh-shaped current collector may include a nickel mesh or a titanium mesh. The metal mesh may be coarse or fine.

The anode layer 132 may include an active metal anode. As used herein, the term “active metal anode” refers to an anode used as an anode active material. An active metal of the active metal anode may be at least one of sodium or a sodium alloy. Examples of the sodium alloy may include sodium, and one or an alloy selected from an alkaline earth metal such as calcium, magnesium, or barium, and/or a transition metal such as zinc.

The active metal anode may have a thickness of 10 μm or more. The active metal anode may have a thickness of about 10 μm to about 20 μm, about 20 μm to about 60 μm, about 60 μm to about 100 μm, about 100 μm to about 200 μm, about 200 μm to about 600 μm, about 600 μm to about 1,000 μm, about 1 mm to about 6 mm, about 6 mm to about 10 mm, about 10 mm to about 60 mm, about 60 mm to about 100 mm, or about 100 mm to about 600 mm.

A protective film may be disposed on one side and/or side surface of the anode layer 132 which is not in contact with the solid electrolyte layer 142. The protective layer may serve as an impermeable film that blocks the transfer of liquid and/or gaseous components, such as moisture and oxygen, from the external environment. Since side reactions between external components and the active metal anode are suppressed by the protective film, the life characteristics of the all-solid sodium air battery 110 may be improved.

The protective film may be inert to electrode reactions. Since the protective film is inert to electrode reactions of the active metal anode, side reactions between the active metal anode and the protective film may be prevented. That is, the protective film may not generate by-products such as metal carbonates and metal oxides that are generated in oxidation and/or reduction reactions of the active metal anode.

The protective film may be an electron insulating layer. Since the protective film is an insulator, a short circuit between the active metal anode and an external conductive member may be prevented. For example, the protective film may have a resistivity of 1×10¹⁰ ohm-meters (Om) or more.

The protective film may be an ion non-conducting film. The protective film may block oxygen and/or moisture and simultaneously may block active metal ions. For example, ion conductivity of the protective film 20 at a temperature of about 25° C. may be 1 x10⁻¹⁰ S/cm or less.

The protective film may have a thickness of 0.1 μm or more. When the protective film is excessively thin, oxygen barrier properties may be reduced. An upper limit of the thickness of the protective film is not particularly limited, but may selected within a range that does not deteriorate the workability and the energy density per unit volume of a battery. For example, the thickness of the protective film in the anode layer 132 may be in a range of about 0.1 μm to about 100 μm.

The protective film may be an organic film or an organic-inorganic composite film. The protective film may include an organic film including an oxygen-barrier polymer and an organic-inorganic composite film including an oxygen-barrier polymer and an inorganic material. The protective film may include an oxygen- and moisture-barrier polymer.

For example, the protective film may include at least one of PVA or a PVA blend. The PVA blend may include PVA and a polymer having excellent compatibility with PVA. Examples of the polymer may include at least one of polymethyl methacrylate, polymethyl acrylate, polyethyl methacrylate, polyethyl acrylate, polypropyl methacrylate, polypropyl acrylate, polybutyl acrylate, polybutyl methacrylate, polypentyl methacrylate, polypentyl acrylate, polycyclohexyl methacrylate, polycyclohexyl acrylate, polyhexyl methacrylate, polyhexyl acrylate, polyglycidyl acrylate, polyglycidyl methacrylate, or polyacrylonitrile. A content of the polymer may be in a range of about 0.1 part by weigh to about 100 parts by weight, for example, about 20 parts by weigh to about 100 parts by weight, with respect to 100 parts by weight of PVA.

Alternatively, the protective film may include at least one of: a polymerization product of at least one polyfunctional monomer of a polyfunctional acrylic monomer or a polyfunctional vinyl-based monomer; and a polymerization product of at least one polyfunctional monomer, which is at least one of a polyfunctional acrylic monomer, a polyfunctional vinyl-based monomer, or a polythiol having three or four thiol groups.

For example, the protective film may include: PVA; a blend of PVA and at least one polymer of polymethyl methacrylate, polymethyl acrylate, polyethyl methacrylate, polyethyl acrylate, polypropyl methacrylate, polypropyl acrylate, polybutylacrylate, polybutyl methacrylate, polypentyl methacrylate, polypentyl acrylate, polycyclohexyl methacrylate, polycyclohexyl acrylate, polyhexyl methacrylate, polyhexyl acrylate, polyglycidyl acrylate, polyglycidyl methacrylate, or polyacrylonitrile; and a polymerization product of pentaerythritol tetrakis(3-mercaptopropionate) or 1,3,5-triallyl-1,3,5-triazine-2,4,6-trione.

In some cases, when the protective film is present, the anode current collector 134 may not be included. When the anode current collector 134 is not included, the energy density per unit weight of a battery may be significantly improved.

### Cathode Current Collector 122 and Cathode Layer 124

The cathode current collector 122 may include an oxygen-permeable porous substrate supporting an oxygen redox catalyst. The oxygen redox catalyst may be a layer formed or applied on an oxygen-permeable porous substrate. The oxygen-permeable porous substrate may be impregnated with an oxygen redox catalyst material.

The oxygen-permeable porous substrate may be a paper or fabric substrate made of carbon and graphite, or a substrate formed from at least one of porous aluminum, titanium, nickel, or an alloy thereof. Optionally, the paper or fabric substrate may have a thickness of about 100 μm to about 400 μm, may be hydrophobic, and may have a water contact angle of 90° or more. Hydrophobicity may be provided by adding 5% to 50% of a hydrophobic polymer binder, such as polyvinylidene fluoride (PVDF) or Teflon, to a substrate. The paper or fabric substrate may include any commercially available porous fabric and paper substrates.

The oxygen redox catalyst may include a noble metal of gold and/or a platinum group (Pt, Ru, Pd, and Ir) and an alloy thereof. Optionally, a catalyst may include an oxide having a spinel, perovskite, or pyrochlore structure, for example, MnO₂, Ag, Co₃O₄, La₂O₃, LaNiO₃, NiCo₂O₄, and LaMnO₃.

Alternatively, the oxygen redox catalyst may be synthesized through electroless deposition on a carbon support by using a reducing agent in an acidic medium such as NaBH₄, or carbon-free nanoparticles, or through a polyol method using ethylene glycol, diethylene glycol, or others, and thus nanoparticles having a size of 100 nm or less, or more specifically, less than 10 nm may be used. The catalyst may optionally include a transition metal, for example Co, Ni, Fe and/or an alloy thereof, and/or a noble metal selected from a platinum group (Pt, Ru, Pd, and Ir) and/or an alloy therewith or Co, Ni, or Fe. The catalysts may be used by themselves or may be partially or fully oxidized to form oxide-coated metal catalysts or metal oxide “nano-sized catalysts.”

In addition, the oxygen redox catalyst may be supported on a carrier. The carrier may be an oxide, a zeolite, a clay mineral, carbon, or the like. The oxide may include at least one of oxides such as alumina, silica, zirconium oxide, and titanium dioxide. The oxide may be an oxide including at least one metal of Ce, Pr, Sm, Eu, Tb, Tm, Yb, Sb, Bi, V, Cr, Mn, Fe, Co, Ni, Cu, Nb, Mo, or W. Carbon may be carbon black such as Ketjen black, acetylene black, channel black, or lamp black, graphite such as natural graphite, artificial graphite, or expanded graphite, activated carbon, or a carbon fiber, but one or more embodiments are not necessarily limited thereto. Any material may be used as long as the material may be used as a carrier in the art.

In the cathode layer 124, oxygen may be used as a cathode active material, and a conductive material may be used.

The conductive material may be porous. Therefore, as a porous conductive material, any material may be used without limitation as long as the material is porous and conductive, and for example, a carbon-based material having porosity may be used. The carbon-based material may include a carbon black-based, graphite-based, graphene-based, activated carbon-based, or carbon fiber-based material. Specifically, the carbon-based material may include at least one of carbon nanoparticles, carbon nanotubes (for example, single-walled carbon nanotubes (SWCNTs) or multi-walled carbon nanotubes (MWCNTs)), carbon nanofibers, carbon nanosheets, carbon nanorods, or carbon nanobelts, but one or more embodiments are not necessarily limited thereto. Any carbon-based material may be used as long as the carbon-based material has a nanostructure. The carbon-based material may have a microsize in addition to a nanostructure. For example, the carbon-based material may have various forms having a microsize, that is, the form of particles, tubes, fibers, sheets, rods, or belts. For example, the carbon-based material may be mesoporous. For example, the carbon-based material may be partially or fully porous. By including a porous carbon-based material, porosity may be introduced into the cathode layer 124, thereby forming the porous cathode layer 124. Since the carbon-based material has porosity, a contact area with the solid electrolyte layer 142 may increase. In addition, it may be easy to supply and diffuse oxygen inside the cathode layer 124, and a space in which products generated during a charging or discharging process are attached may be provided.

In addition, the conductive material may include a metallic conductive material such as a metal fiber or a metal mesh. The conductive material may include a metallic powder of copper, silver, nickel, aluminum, or the like. An organic conductive material such as a polyphenylene derivative may be used. The conductive materials may be used alone or in combination.

The cathode layer 124 may be a composite cathode layer 124 including an electrolyte in addition to a porous material. An electrolyte may include at least one of a polymer electrolyte, an inorganic electrolyte, an organic-inorganic composite electrolyte, or an ionic liquid. When the cathode layer 124 includes an electrolyte, diffusion of oxygen inside the cathode layer 124 may become easier, and an area of the electrolyte in contact with oxygen may increase. A composition ratio of the porous material to the electrolyte in the cathode layer 124 may be in a range of about 1:2 to about 1:9 by weight. That is, a sodium air battery having further improved charging/discharging characteristics may be obtained in a range in which the electrolyte is included in an amount of about 200 parts by weight to about 900 parts by weight with respect to 100 parts by weight of the porous material. The electrolyte may include, for example, an ionic liquid such as N,N-diethyl-methylamine trifluoromethanesulfonate (DEMA), 1-methyl-3-propylpyrrolidinium bis(trifluoromethanesulfonyl)imide (PP13TFSI), or N-methyl-N-propylpiperidinium bistrifluoromethanesulfonyl amide (PP13-TFSA). The electrolyte may be a component in which sodium is doped into at least one of polyethylene oxide (PEO), PVA, polyvinyl pyrrolidone (PVP), or polyvinyl sulfone, or a polymer that is a combination thereof. For example, an ion-conductive polymer solid electrolyte may be PEO doped with a sodium salt.

The cathode layer 124 may include the above-described oxygen redox catalyst and/or a carrier.

The cathode layer 124 may additionally include a binder. The binder may include a thermoplastic resin or a thermosetting resin. For example, polyethylene, polypropylene, polytetrafluoroethylene (PTFE), PVDF, styrene-butadiene rubber, a tetrafluoroethylene-perfluoroalkyl vinyl ether copolymer, a vinylidene fluoride-hexafluoro propylene copolymer, a vinylidene fluoride-chlorotrifluoroethylene copolymer, an ethylene-tetrafluoroethylene copolymer, polychlorotrifluoroethylene, a vinylidene fluoride-pentafluoro propylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethyl vinyl ether-tetrafluoro ethylene copolymer, and an ethylene-acrylic acid copolymer may be used alone or in mixture, but one or more embodiments are not necessarily limited thereto. Any material may be used as long as the material may be used as a binder in the art.

The cathode layer 124 may be prepared by, for example, mixing an oxygen redox catalyst, a conductive material, and a binder, adding a suitable solvent, preparing a slurry of the cathode layer 124, and then applying the slurry onto a surface of the cathode current collector 122 to dry the slurry, or optionally pressing and molding the slurry on the cathode current collector 122 to improve electrode density. In addition, the cathode layer 124 may optionally include sodium oxide. Furthermore, the oxygen redox catalyst may be optionally omitted.

Alternatively, the cathode layer 124 may be prepared by mixing a porous carbon-based material with a composition of the cathode layer 124 including an electrolyte at room temperature.

### Solid Electrolyte Layer

The solid electrolyte layer 142 of a solid ion conductor having the composition described above may be used. The solid electrolyte layer 142 may have a thickness of about 10 μm to about 1 mm, about 10 μm to about 900 μm, about 10 μm to about 800 μm, about 10 μm to about 600 μm, about 10 μm to about 400 μm, or about 10 μm to about 200 μm.

Although not shown, the all-solid sodium air battery 110 may include one or more separators separating the anode layer 132 and the cathode layer 124.

The separator may be a polymer film, for example a porous polymer film which is non-reactive to metallic sodium, oxygen, and sodium oxide, for example NaO₂ or Na₂O₂, and an electrolyte component. For example, the separator may include polyolefin, specifically, porous polyethylene having a film form and porous polypropylene having a film form. A separator consisting of polyolefin such as polyethylene or polypropylene may have a porosity in a range of about 35% to about 45%. The separator may have a pore diameter of, for example, about 30 nm to about 500 nm.

Alternatively, the separator may be a separator consisting of an inorganic nonwoven fabric, for example, a glass fiber nonwoven fabric and a ceramic fiber nonwoven fabric.

Alternatively, the separator may be a separator composed of a thin layer of an inorganic material permeable to sodium ions, such as beta-alumina or NaSICON (Na₃Zr₂Si₂PO₁₂).

The insulator housing 111 may serve to electrically insulate the all-solid sodium air battery 110 to prevent an electrical short circuit due to externally applied electricity.

The anode current collector 134 and the anode layer 132 may be installed on one side of a case, the solid electrolyte layer 142 may be disposed on the anode layer 132, and the cathode layer 124 may be disposed on the solid electrolyte layer 142. Carbon paper as a gas diffusion layer and the cathode current collector 122 may be sequentially stacked on the cathode layer 124, and the air exposure holes 115 for contacting air may be formed at both sides of the cathode layer 124. The insulator housing 111 composed of an insulator may be disposed at both sides of the anode current collector 134, the anode layer 132, the solid electrolyte layer 142, the cathode layer 124, and the cathode current collector 122 to block the all-solid sodium air battery 110 from the outside, and a cell may be fixed there onto by being pressed with a pressing member, through which air may be transferred to an air electrode, thereby completing the all-solid sodium air battery 110.

A plurality of all-solid sodium air batteries 110 may be stacked in a thickness direction to constitute an all-solid sodium air battery 110 module.

The all-solid sodium air battery 110 may also be applied to large batteries used in electric vehicles, or the like.

The term “air” used herein is not limited to atmospheric air and may include a combination of gases including oxygen or a pure oxygen gas. The broad definition of the term “air” may be applied to all applications, for example, air cells and air electrodes.

Hereinafter, Examples and Comparative Examples will be described. However, the following Examples are merely examples of the disclosure, and the disclosure is not limited to the following Examples.

### EXAMPLES

### Preparation of Solid Ion Conductor

### Example 1: Na_{5.9}P_{0.9}W_{0.1}S₅Cl₁ Solid Ion Conductor

Raw materials in which Na₂S, P₂S₅, WS₂, S, and NaCl were put into a reactor in a stoichiometric ratio were prepared to obtain a Na_{5.9}P_{0.9}W_{0.1}S₅Cl₁ solid ion conductor. A cycle, in which the raw materials were mixed at a rotational speed of 600 rpm for 15 minutes by using a planetary mill (Pulverisette 7 premium line) with yttrium-stabilized zirconia (YSZ) balls having a diameter of 10 mm and were rested for 5 minutes, was repeated for 8 hours to obtain a milled mixture. The milled mixture was put into a Pyrex glass tube, and an inlet was sealed with a torch under vacuum and reduced pressure. A sealed glass ampoule was heat-treated at a temperature of about 450° C. for 12 hours in a box furnace to prepare a tube-shaped Na_{5.99}P_{0.9}W_{0.1}S₅Cl₁ crystalline solid ion conductor pellet.

### Example 2: Na_{5.3}P_{0.8}W_{0.2}S_{4.5}Cl_{1.5} Solid Ion Conductor

A tube-shaped Na_{5.3}P_{0.8}W_{0.2}S_{4.5}Cl_{1.5} crystalline solid ion conductor pellet was prepared in the same manner as in Example 1, except that raw materials in which Na₂S, P₂S₅, WS₂, S, and NaCl were put into a reactor in a stoichiometric ratio were used to obtain a Na_{5.3}P_{0.8}W_{0.2}S_{4.5}Cl_{1.5} solid ion conductor.

### Example 3: Na_{5.7}P_{0.9}W_{0.1}S_{4.8}Cl_{1.2} Solid Ion Conductor

A tube-shaped Na_{5.7}P_{0.9}W_{0.1}S_{4.8}Cl_{1.2} crystalline solid ion conductor pellet was prepared in the same manner as in Example 1, except that raw materials in which Na₂S, P₂S₅, WS₂, S, and NaCl were put into a reactor in a stoichiometric ratio were used to obtain a Na_{5.7}P_{0.9}W_{0.1}S_{4.5}Cl_{1.2} solid ion conductor.

### Example 4: Na_{5.4}P_{0.9}W_{0.1}S_{4.5}Cl_{1.5} Solid Ion Conductor

A tube-shaped Na_{5.4}P_{0.9}W_{0.1}S_{4.5}Cl_{1.5} crystalline solid ion conductor pellet was prepared in the same manner as in Example 1, except that raw materials in which Na₂S, P₂S₅, WS₂, S, and NaCl were put into a reactor in a stoichiometric ratio were used to obtain a Na_{5.4}P_{0.9}W_{0.1}S_{4.5}Cl_{1.5} solid ion conductor.

### Example 5: Na_{5.2}P_{0.9}W_{0.1}S_{4.3}Cl_{1.7} Solid Ion Conductor

A tube-shaped Na_{5.2}P_{0.9}W_{0.1}S_{4.3}Cl_{1.7} crystalline solid ion conductor pellet was prepared in the same manner as in Example 1, except that raw materials in which Na₂S, P₂S₅, WS₂, S, and NaCl were put into a reactor in a stoichiometric ratio were used to obtain a Na_{5.2}P_{0.9}W_{0.1}S_{4.3}Cl_{1.7} solid ion conductor.

### Example 6: Na_{4.9}P_{0.9}W_{0.1}S₄Cl₂ Solid Ion Conductor

A tube-shaped Na_{4.9}P_{0.9}W_{0.1}S₄Cl₂ crystalline solid ion conductor pellet was prepared in the same manner as in Example 1, except that raw materials in which Na₂S, P₂S₅, WS₂, S, and NaCl were put into a reactor in a stoichiometric ratio were used to obtain a Na_{4.9}P_{0.9}W_{0.1}S₄Cl₂ solid ion conductor.

### Example 7: Na_{5.9}P_{0.9}W_{0.1}S₅Br₁ Solid Ion Conductor

A tube-shaped Na_{5.9}P_{0.9}W_{0.1}S₅Br₁ crystalline solid ion conductor pellet was prepared in the same manner as in Example 1, except that raw materials in which Na₂S, P₂S₅, WS₂, S, and NaBr were put into a reactor in a stoichiometric ratio were used to obtain a Na_{5.9}P_{0.9}W_{0.1}S₅Br₁ solid ion conductor.

### Example 8: Na_{5.4}P_{0.9}W_{0.1}S_{4.5}Br_{1.5} Solid Ion Conductor

A tube-shaped Na_{5.4}P_{0.9}W_{0.1}S_{4.5}Br_{1.5} crystalline solid ion conductor pellet was prepared in the same manner as in Example 1, except that raw materials in which Na₂S, P₂S₅, WS₂, S, and NaBr were put into a reactor in a stoichiometric ratio were used to obtain a Na_{5.4}P_{0.9}W_{0.1}S_{4.5}Br_{1.5} solid ion conductor.

### Comparative Example 1: Na₆P₁S₅Cl₁ Solid Ion Conductor

A tube-shaped Na₆P₁S₅Cl₁ crystalline solid ion conductor pellet was prepared in the same manner as in Example 1, except that raw materials in which Na₂S, P₂S₅, S, and NaCl were put into a reactor in a stoichiometric ratio were used to obtain a Na₆P₁S₅Cl₁ solid ion conductor.

### Comparative Example 2: Na_{5.5}P₁S_{4.5}Cl_{1.5} Solid Ion Conductor

A tube-shaped Na_{5.5}P₁S_{4.5}Cl_{1.5} crystalline solid ion conductor pellet was prepared in the same manner as in Example 1, except that raw materials in which Na₂S, P₂S₅, S, and NaCl were put into a reactor in a stoichiometric ratio were used to obtain a Na_{5.5}P₁S_{4.5}Cl_{1.5} solid ion conductor.

### Comparative Example 3: Na_{4.4}P_{0.9}W_{0.1}S_{3.5}Cl_{2.5} Solid Ion Conductor

A tube-shaped Na_{4.4}P_{0.9}W_{0.1}S_{3.5}Cl_{2.5} crystalline solid ion conductor pellet was prepared in the same manner as in Example 1, except that raw materials in which Na₂S, P₂S₅, WS₂, S, and NaCl were put into a reactor in a stoichiometric ratio were used to obtain a Na_{4.4}P_{0.9}W_{0.1}S_{3.5}Cl_{2.5} solid ion conductor.

### Comparative Example 4: Na_{5.6}P_{0.9}Sn_{0.1}S_{4.5}Cl_{1.5} Solid Ion Conductor

A tube-shaped Na_{5.6}P_{0.9}Sn_{0.1}S_{4.5}Cl_{1.5} crystalline solid ion conductor pellet was prepared in the same manner as in Example 1, except that raw materials in which Na₂S, P₂S₅, SnS₂, S, and NaCl were put into a reactor in a stoichiometric ratio were used to obtain a Na_{5.6}P_{0.9}Sn_{0.1}S_{4.5}Cl_{1.5} solid ion conductor.

### Comparative Example 5: Na_{5.7}P_{0.9}Al_{0.1}S_{4.5}Cl_{1.5} Solid Ion Conductor

A tube-shaped Na_{5.7}P_{0.9}Al_{0.1}S_{4.5}Cl_{1.5} crystalline solid ion conductor pellet was prepared in the same manner as in Example 1, except that raw materials in which Na₂S, P₂S₅, AlS₂, S, and NaCl were put into a reactor in a stoichiometric ratio were used to obtain a Na_{5.7}P_{0.9}Al_{0.1}S_{4.5}Cl_{1.5} solid ion conductor.

### Evaluation Example 1: Sodium Ion Conductivity Analysis

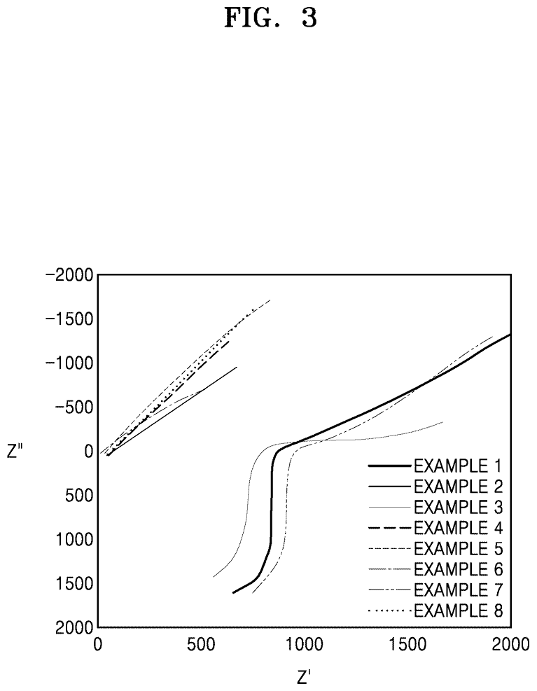

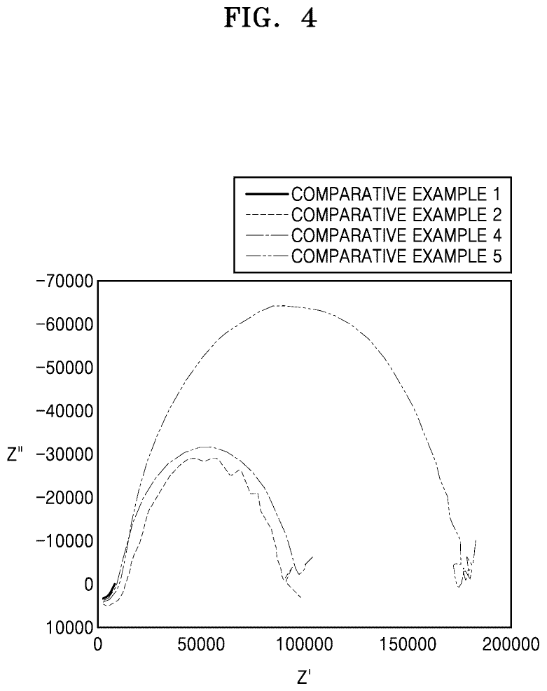

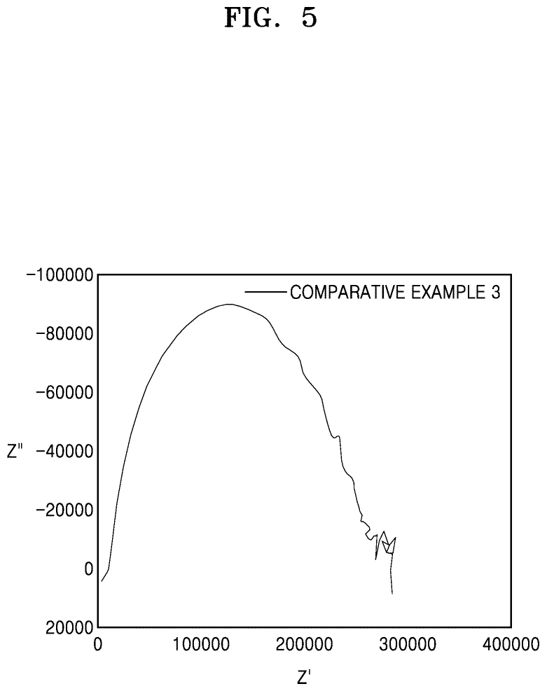

The solid ion conductors prepared in Examples 1 to 8 and Comparative Examples 1 to 5 were pulverized by using a mortar, thereby preparing a solid ion conductor having a powder form. 200 milligrams (mg) of the solid ion conductor having a powder form was pressed at a pressure of 4 tonnes per square centimeters (ton/cm²) for 2 minutes to prepare a pellet specimen with a thickness of about 900 μm and a diameter of about 13 mm. A symmetric cell was manufactured by arranging an indium (In) electrode with a thickness of 50 μm and a diameter of 13 mm on each of both sides of a sample. The symmetric cell was manufactured in a glover box in an argon (Ar) atmosphere. Electrochemical impedance spectroscopy (EIS) analysis was performed by connecting wires to both sides of each symmetric cell. The EIS analysis was performed at an amplitude of about 10 mV and a frequency in a range of 1 hertz (Hz) to 10⁶ Hz. The impedance of a pellet was measured at room temperature (25° C.) through a two-probe method using a potentiostat/galvanostat and a 1455 frequency response analyzer (FRA) multi-channel test module (Solatron Analytical, UK) as an impedance analyzer. Impedance measurement results are shown in FIGS. 3 to 5. Afterwards, a resistance value was obtained from an arc of a Nyquist plot for the impedance measurement results, and ion conductivity was calculated therefrom by correcting an electrode area and a pellet thickness. Results thereof are shown in Table 1 below.

TABLE 1

| | Na ion conductivity |
|---|---|
| | (mS/cm, @ 25° C.) |
| Example 1 | 0.0690 |
| Example 2 | 1.04 |
| Example 3 | 0.0758 |
| Example 4 | 0.993 |
| Example 5 | 1.37 |
| Example 6 | 2.88 |
| Example 7 | 0.0626 |
| Example 8 | 1.11 |
| Comparative Example 1 | 0.00812 |
| Comparative Example 2 | 0.0187 |
| Comparative Example 3 | 0.00574 |
| Comparative Example 4 | 0.000626 |
| Comparative Example 5 | 0.000344 |

As shown in Table 1, solid ion conductors solid electrolytes prepared in Examples 1 to 8 had a Na ion conductivity of 0.0626 mS/cm or more which was higher as compared to solid ion conductors solid electrolytes prepared in Comparative Examples 1 to 5. That is, the Na ion conductivity of the solid ion conductor-containing solid electrolytes prepared in Examples 1 to 8 in which all of cations and anions were substituted was higher than that of the solid ion conductor-containing solid electrolytes prepared in Comparative Examples 1, 2, 4, and 5 in which only cations or anions were substituted.

In addition, when the solid ion conductor-containing solid electrolytes prepared in Examples 1 and 2 were compared with each other, as a tungsten (W) substitution amount increased, the Na ion conductivity increased. When the solid ion conductor-containing solid electrolytes prepared in Examples 1, 3, and 5 to 7 were compared with each other, as a chlorine (Cl) substitution amount increased, Na ion conductivity gradually increased. When the solid ion conductor-containing solid electrolytes prepared in Examples 4 and 9 were compared with each other, the Na ion conductivity of a bromine (Br)-substituted solid ion conductor-containing solid electrolyte was relatively higher than that of a chlorine (Cl)-substituted solid ion conductor-containing solid electrolyte.

Thus, it has been confirmed that a solid electrolyte including a solid ion conductor of the disclosure may have high Na ion conductivity and may be stably applied to an all-solid sodium battery.

A method of preparing a solid electrolyte includes:
mechanically milling a solid ion conductor-forming precursor to provide a solid ion conductor-forming precursor mixture; and
heat-treating the solid ion conductor-forming precursor mixture to prepare a solid ion conductor represented by Formula 1 below:

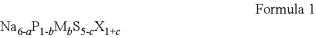

wherein, in Formula 1,
M is a transition metal element having an oxidation number of +6,
X is a halogen,
0≤a<2, 0<b≤1, and 0≤c≤1.

The mechanical milling may be ball milling, air-jet milling, bead milling, roll milling, hand milling, high-energy ball milling, stirred ball milling, vibrating milling, mechanofusion milling, shaker milling, planetary milling, attritor milling, disk milling, shape milling, nauta milling, nobilta milling, high-speed mixing, or a combination thereof.

The mechanical milling may be planetary milling and performed at room temperature.

The heat-treating may be performed at a temperature of about 400° C. to about 500° C. in a vacuum atmosphere.

In Formula 1, M may include at least one of tungsten (W), molybdenum (Mo), chromium (Cr), manganese (Mn), technetium (Tc), ruthenium (Ru), osmium (Os), iron (Fe), rhodium (Rh), rhenium (Re), or iridium (Ir).

In Formula 1, X may include at least one of chlorine (Cl), bromine (Br), or iodine (I).

In an embodiment, in Formula 1 described above, 0<b≤0.5.

A solid electrolyte according to an aspect may include a solid ion conductor represented by Formula 1. The solid electrolyte may have high Na ion conductivity and high electrochemical stability.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the FIGS., it will be understood by those of ordinary skill in the art that various changes in form and details may be made therein without departing from the spirit and scope as defined by the following claims.

What is claimed is:

1. A solid electrolyte comprising a solid ion conductor represented by Formula 1 below: 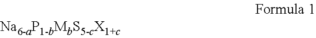
wherein, in Formula 1,
M is a transition metal element having an oxidation number of +6,
X is a halogen,
0≤a<2, 0<b<1, and 0≤c≤1.

2. The solid electrolyte of claim 1, wherein, in Formula 1, M comprises at least one of tungsten, molybdenum, chromium, manganese, technetium, ruthenium, osmium, iron, rhodium, rhenium, or iridium.

3. The solid electrolyte of claim 1, wherein in Formula 1, X comprises at least one of chlorine, bromine, or iodine.

4. The solid electrolyte of claim 1, wherein, in Formula 1, 0<b≤0.5.

5. The solid electrolyte of claim 1, wherein the solid ion conductor comprises at least one of:
Na_{5.9}P_{0.9}W_{0.1}S₅Cl₁, Na_{5.9}P_{0.9}W_{0.1}S₅Br₁, Na_{5.9}P_{0.9}W_{0.1}S₅I₁, Na_{5.7}P_{0.9}W_{0.1}S_{4.8}Cl_{1.2}, Na_{5.7}P_{0.9}W_{0.1}S_{4.8}Br_{1.2}, Na_{5.7}P_{0.9}W_{0.1}S_{4.8}I_{1.2}, Na_{5.4}P_{0.9}W_{0.1}S_{4.5}Cl_{1.5}, Na_{5.4}P_{0.9}W_{0.1}S_{4.5}Br_{1.5}, Na_{5.4}P_{0.9}W_{0.1}S_{4.5}I_{1.5}, Na_{5.3}P_{0.8}W_{0.2}S_{4.5}Cl_{1.5}, Na_{5.3}P_{0.8}W_{0.2}S_{4.5}Br_{1.5}, Na_{5.3}P_{0.8}W_{0.2}S_{4.5}I_{1.5}, Na_{5.2}P_{0.9}W_{0.1}S_{4.3}Cl_{1.7}, Na_{5.2}P_{0.9}W_{0.1}S_{4.3}Br_{1.7}, Na_{5.2}P_{0.9}W_{0.1} S_{4.31}I_{1.7}, Na_{4.9}P_{0.9}W_{0.1} S₄Cl₂, Na_{4.9}P_{0.9}W_{0.1}S₄Br₂, or Na_{4.9}P_{0.9}W_{0.1}S₄I₂;
Na_{5.9}P_{0.9}Mo_{0.1}S₅Cl₁, Na_{5.9}P_{0.9}Mo_{0.1}S₅Br₁, Na_{5.9}P_{0.9}Mo_{0.1}S₅I₁, Na_{5.7}P_{0.9}Mo_{0.1}S_{4.8}Cl_{1.2}, Na_{5.7}P_{0.9}Mo_{0.1}S_{4.8}Br_{1.2}, Na_{5.7}P_{0.9}Mo_{0.1}S_{4.8}I_{1.2}, Na_{5.4}P_{0.9}Mo_{0.1}S_{4.5}Cl_{1.5}, Na_{5.4}P_{0.9}Mo_{0.1}S_{4.5}Br_{1.5}, Na_{5.4}P_{0.9}Mo_{0.1}S_{4.5}I_{1.5}, Na_{5.3}P_{0.8}Mo_{0.2}S_{4.5}Cl_{1.5}, Na_{5.3}P_{0.8}Mo_{0.2}S_{4.5}Br_{1.5}, Na_{5.3}P_{0.8}Mo_{0.2}S_{4.5}I_{1.5}, Na_{5.2}P_{0.9}Mo_{0.1}S_{4.3}Cl_{1.7}, Na_{5.2}P_{0.9}Mo_{0.1}S_{4.3}Br_{1.7}, Na_{5.2}P_{0.9}Mo_{0.1}S_{4.31}I_{1.7}, Na_{4.9}P_{0.9}Mo_{0.1}S₄Cl₂, Na_{4.9}P_{0.9}Mo_{0.1}S₄Br₂, or Na_{4.9}P_{0.9}Mo_{0.1}S₄I₂; and
Na_{5.9}P_{0.9}Cr_{0.1}S₅Cl₁, Na_{5.9}P_{0.9}Cr_{0.1}S₅Br₁, Na_{5.9}P_{0.9}Cr_{0.1}S₅I₁, Na_{5.7}P_{0.9}Cr_{0.1}S_{4.8}Cl_{1.2}, Na_{5.7}P_{0.9}Cr_{0.1}S_{4.8}Br_{1.2}, Na_{5.7}P_{0.9}Cr_{0.1}S_{4.8}I_{1.2}, Na_{5.4}P_{0.9}Cr_{0.1}S_{4.5}Cl_{1.5}, Na_{5.4}P_{0.9}Cr_{0.1}S_{4.5}Br_{1.5}, Na_{5.4}P_{0.9}Cr_{0.1}S_{4.5}I_{1.5}, Na_{5.3}P_{0.8}Cr_{0.2}S_{4.5}Cl_{1.5}, Na_{5.3}P_{0.8}Cr_{0.2}S_{4.5}Br_{1.5}, Na_{5.3}P_{0.8}Cr_{0.2}S_{4.5}I_{1.5}, Na_{5.2}P_{0.9}Cr_{0.1}S_{4.3}Cl_{1.7}, Na_{5.2}P_{0.9}Cr_{0.1}S_{4.3}Br_{1.7}, Na_{5.2}P_{0.9}Cr_{0.1}S_{4.31}I_{1.7}, Na_{4.9}P_{0.9}Cr_{0.1}S₄Cl₂, Na_{4.9}P_{0.9}Cr_{0.1}S₄Br₂, or Na_{4.9}P_{0.9}Cr_{0.1}S₄I₂.

6. The solid electrolyte of claim 1, wherein the solid ion conductor comprises a solid ion conductor represented by Formula 2: 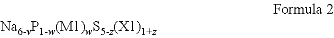
wherein, in Formula 2,
M1 is tungsten or molybdenum,
X1 is chlorine, bromine, or iodine,
0≤v≤1.3, 0<w<0.3, and 0≤z≤1.

7. The solid electrolyte of claim 1, wherein the solid ion conductor comprises an argyrodite-based crystalline material.

8. The solid electrolyte of claim 1, wherein the solid ion conductor has a composition in which phosphorus has an oxidation number of +5 and sulfur has an oxidation number of −2.

9. The solid electrolyte of claim 1, wherein the solid ion conductor has a crystalline form in which a sodium vacancy is increased based on Na₆P₁S₅Cl₁.

10. The solid electrolyte of claim 1, wherein the solid ion conductor has a sodium ion conductivity of about 1.0×10⁻³ milliSiemen per centimeter to about 3.0×10¹ milliSiemen per centimeter at 25° C.

11. A sodium battery comprising:
a cathode layer;
an anode layer; and
a solid electrolyte layer disposed between the cathode layer and the anode layer,
wherein at least one of the cathode layer, the anode layer, or the solid electrolyte layer comprises a solid electrolyte including a solid ion conductor represented by Formula 1 below: 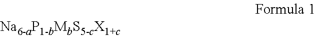
wherein, in Formula 1,
M is a transition metal element having an oxidation number of +6,
X is a halogen,
0≤a<2, 0<b≤1, and 0≤c≤1.

12. The sodium battery of claim 11, wherein, in Formula 1, M comprises at least one of tungsten, molybdenum, chromium, manganese, technetium, ruthenium, osmium, iron, rhodium, rhenium, or iridium.

13. The sodium battery of claim 11, wherein, in Formula 1, 0<b≤0.5.

14. The sodium battery of claim 11, wherein the cathode layer comprises a compound represented by Formula 12 below: 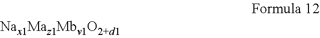
wherein, in Formula 12,
Ma is at least one element of iron (Fe), manganese (Mn), cobalt (Co), nickel (Ni), ruthenium (Ru), osmium (Os), chromium (Cr), molybdenum (Mo), vanadium (V), or tungsten (W),
Mb is at least one element of Groups 4, 5, 7, 9, or 10 of the periodic table of the elements,
0.3≤x1<2, 0<z1≤5, 0≤v1≤0.7, and 0≤d1<1.

15. The sodium battery of claim 11, wherein the cathode layer further comprises the solid electrolyte,
wherein a content of the solid electrolyte is in a range of about 1 part by weight to about 40 parts by weight with respect to 100 parts by weight of a total weight of the cathode layer.

16. The sodium battery of claim 11, wherein the anode layer comprises sodium metal, a sodium metal-based alloy, a sodium intercalating compound, a carbon-based material, or a combination thereof.

17. The sodium battery of claim 11, wherein the anode layer comprises an anode active material layer of the sodium metal,
wherein the anode active material layer has a thickness of about 3 micrometers to about 500 micrometers.

18. The sodium battery of claim 11, wherein the solid electrolyte is further included in a protective film of the cathode layer or a protective film of the anode layer, or both of the protective films of the cathode layer and the anode layer.

19. The sodium battery of claim 11, wherein the sodium battery is a sodium ion battery or a sodium air battery.

20. A sodium battery module comprising:
a cathode layer;
an anode layer; and
a solid electrolyte layer disposed between the cathode layer and the anode layer,
wherein at least one of the cathode layer, the anode layer, and the solid electrolyte layer comprises a solid electrolyte comprising a solid ion conductor represented by Formula 1 below: 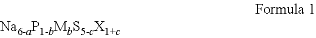
wherein, in Formula 1,
M is a transition metal element having an oxidation number of +6,
X is a halogen,
0≤a<2, 0<b<1, and 0≤c≤1.
